(19) United States
(12) Patent Application Publication
(10) Pub. No.: US 2010/0306066 A1
(43) Pub. Date: Dec. 2, 2010

(54) TECHNIQUES FOR DISPLAYING AN ADVERTISEMENT ACROSS MULTIPLE PAGES

(75) Inventors: Andreas Binnewies, Berkeley, CA (US); Vijay Raghunathan, San Francisco, CA (US); Christopher T. Szeto, San Jose, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Meebo, Inc., Mountain View, CA (US)

(21) Appl. No.: 12/790,477

(22) Filed: May 28, 2010

Related U.S. Application Data
(60) Provisional application No. 61/226,644, filed on Jul. 17, 2009.
(60) Provisional application No. 61/183,471, filed on Jun. 2, 2009.

(51) Int. Cl. G06Q 30/00

(52) U.S. Cl. 705/14.73

(57) ABSTRACT

Techniques for persisting an advertisement across multiple web pages served from page-view based websites. The advertisement is persisted across multiple pages served from page-view based websites without creating new advertisement impressions. This reduces the number of advertisement impressions and also extends the amount of time that a particular advertisement can be shown to a user even as the user navigates across multiple web pages.

### CROSS-REFERENCES TO RELATED APPLICATIONS

The present application claims the benefit and priority under 35 U.S.C. 119(e) from the following provisional applications, the entire contents of which are herein incorporated by reference for all purposes:

(1) U.S. Provisional Application No. 61/183,471, filed Jun. 2, 2009, entitled TECHNIQUES FOR DISPLAYING AN ADVERTISEMENT ACROSS MULTIPLE PAGES; and

(2) U.S. Provisional Application No. 61/226,644, filed Jul. 17, 2009, entitled TECHNIQUES FOR CUSTOMIZED DELIVERY OF ADVERTISEMENTS.

The present application also incorporates by reference for all purposes the entire contents of U.S. Non-Provisional application Ser. No. ______ (Attorney Docket No. 028013-000210US) titled TECHNIQUES FOR CUSTOMIZED DELIVERY OF ADVERTISEMENTS filed concurrently with the present application.

### BACKGROUND

Embodiments of the present invention relate to providing information via a communication network such as the Internet, and more particularly to techniques for persisting an advertisement across multiple web pages.

There are several page-view based websites that offer web pages that can be accessed by users. In a page-view based system, as a user navigates from one web page to another, the entire web page is unloaded and the new web page then loaded. For example, when a user navigates from a first web page to a second web page, the entire first web page is unloaded and the second web page is then loaded and rendered to the user. The loading and unloading of web pages may be done within a frame or some other mechanism. This is different from non page-view based Web applications in which updates are made to portions of a page without the page being completely unloaded.

One or more advertisements may also be loaded and displayed along with and in response to web pages accessed by a user. In a page-view based system, when a web page is unloaded, the advertisement displayed on that web page is also unloaded along with the web page. There is no state information stored for the unloaded web page and advertisement. When the next web page is loaded, a new advertisement request is sent to an advertisement server for a new advertisement. A new advertisement received from the advertisement server is then loaded and rendered on the next web page. Accordingly, advertisements are loaded and unloaded with each web page load/unload. This results in multiple advertisement impressions, with at least one advertisement impression for each new loaded web page. This is different from non page-view based applications in which advertisements can persist on a web page because updates are made to the same web page without completely unloading the web page.

FIG. 1 depicts how web pages and advertisements are loaded and unloaded in a conventional page-view based system. As shown in FIG. 1, a user may use a computer (user computer) to access web pages. An advertisement server 100 may serve advertisements that are loaded and displayed with the web pages. In the example depicted in FIG. 1, the user navigates through ten web pages in a little over three minutes. At the start, the user accesses a web page PAGE_1. As a result of PAGE_1 being accessed and loaded, a request is sent to advertisement server 100 for an advertisement to be loaded and displayed with PAGE_1. An advertisement AD_1 received from advertisement server 100 in response to the request is then loaded and displayed along with PAGE_1. Within 15 seconds of accessing PAGE_1, the user accesses another web page PAGE_2. This causes PAGE_1 and AD_1 to be completely unloaded. As a result of PAGE_2 being accessed, a new request is sent to advertisement server 100 for an advertisement to be displayed with PAGE_2. The advertisement AD_2 received from advertisement server 100 in response to the request is then loaded and displayed along with PAGE_2. In a like manner, the user accesses ten web pages in a matter of a little over three minutes. Each time that a new web page is accessed and loaded, a request for an advertisement is sent to advertisement server 100. Advertisement server 100 responds by providing an advertisement, which is then loaded and displayed with the newly loaded web page. In this manner, an advertisement impression (i.e., an advertisement request to the advertisement server) is generated each time that a new web page is loaded. In the prior art example depicted in FIG. 1, ten advertisement impressions are generated in merely a little over three minutes.

With an ever increasing amount of web content being consumed by users, a web page accessed by a user may be loaded for only a matter of seconds before the user moves on to the next page. This causes an advertisement impression for each web page that is loaded. This not only generates an overabundance of advertisement impressions but does not provide the user with enough time to see and/or engage the individual advertisements leading to poor success of the advertisements.

### BRIEF SUMMARY

Embodiments of the present invention provide techniques for persisting an advertisement across multiple web pages served from page-view based websites. The advertisement is persisted across multiple pages served from page-view based websites without creating new advertisement impressions. This reduces the number of advertisement impressions and also extends the amount of time that a particular advertisement can be shown to a user even as the user navigates across multiple web pages.

In one embodiment, techniques are provided for displaying an advertisement on a web page. A user may access a first web page. The first web page may then be loaded and displayed. A first advertisement may be loaded and displayed along with the first web page. Ad-persist information is stored regarding the first advertisement. When the user navigates to a second web page, the first web page and the first advertisement are unloaded. The second web page is then loaded. A determination is made, based upon the ad-persist information, whether the first advertisement is to be displayed for the second web page. If it is determined that the first advertisement is to be displayed for the second web page, the first advertisement is displayed for the second web page using the ad-persist information, wherein the displaying is performed without sending a request for an advertisement to an advertisement server. In this manner, the first advertisement that was displayed for the first web page is also displayed for the second web page without creating an advertisement impression. The first advertisement is thus persisted across multiple web pages.

In one embodiment, upon determining that the first advertisement is not to be displayed for the second web page, a request may be communicated to an advertisement server for another advertisement. A new advertisement served in response to the request may then be loaded for the second web page. The ad-persist information may be updated to store information related to the new advertisement.

In one embodiment, the ad-persist information may be used to persist an advertisement for web pages accessed by different clients such as web pages loaded on two different tabs of a browser.

In one embodiment, the ad-persist information comprises time information. This information is then used to determine whether the advertisement is to be persisted for multiple web page loads. In one embodiment, the time information indicates a time when an advertisement received from an advertisement server was loaded. This time information is then used to determine whether a time period for displaying the advertisement has expired. The same advertisement is persisted upon determining that the time period for displaying the advertisement has not expired. The advertisement is not persisted upon determining that the time period for displaying the advertisement has expired.

The ad-persist information may be stored on a user's (client) computer, on a server, or on both.

The foregoing, together with other features and embodiments will become more apparent upon referring to the following specification, claims, and accompanying drawings.

### BRIEF DESCRIPTION OF THE DRAWINGS

FIG. 1 depicts how web pages and advertisements are loaded and unloaded in a conventional page-view based system;

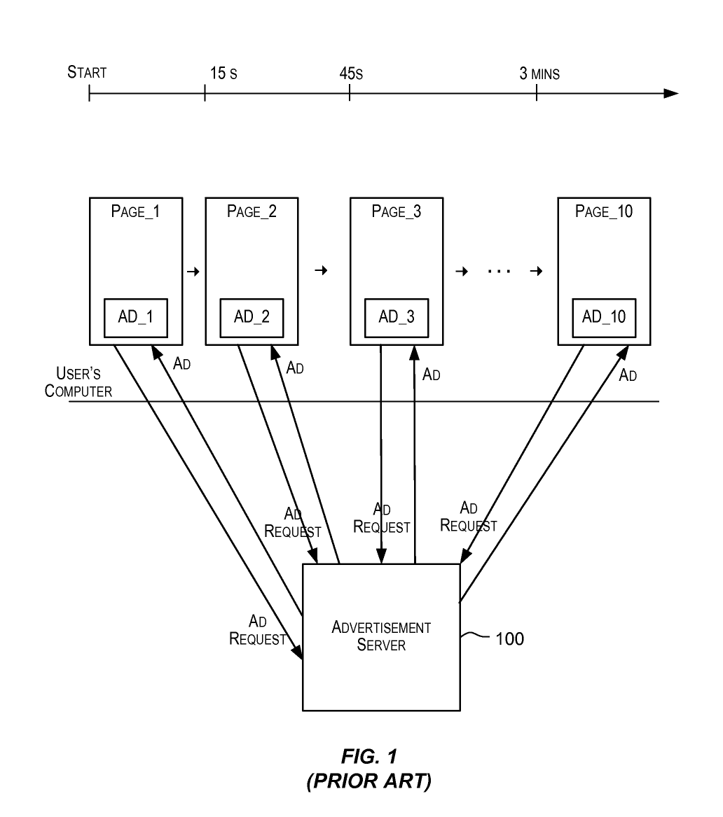

FIG. 2 is a simplified block diagram of a system incorporating an embodiment of the present invention;

FIG. 3 depicts a simplified flowchart depicting a method performed upon loading a new web page in the first (non-login) mode according to an embodiment of the present invention;

FIG. 4 depicts how an advertisement is persisted across multiple web pages accessed by a user in non-login mode according to an embodiment of the present invention;

FIG. 5 depicts a simplified flowchart depicting a method for loading a new web page in login mode according to an embodiment of the present invention;

FIG. 6 depicts how an advertisement is persisted across multiple web pages across multiple clients in login mode according to an embodiment of the present invention; and

FIG. 7 is a simplified block diagram of a computer system that may be used to practice an embodiment of the present invention.

### DETAILED DESCRIPTION

In the following description, for the purposes of explanation, specific details are set forth in order to provide a thorough understanding of embodiments of the invention. However, it will be apparent that the invention may be practiced without these specific details.

Embodiments of the present invention provide techniques for persisting an advertisement across multiple web pages served from page-view based websites. The advertisement is persisted across multiple pages served from page-view based websites without creating new advertisement impressions. This reduces the number of advertisement impressions and also extends the amount of time that a particular advertisement can be shown to a user even as the user navigates across multiple web pages.

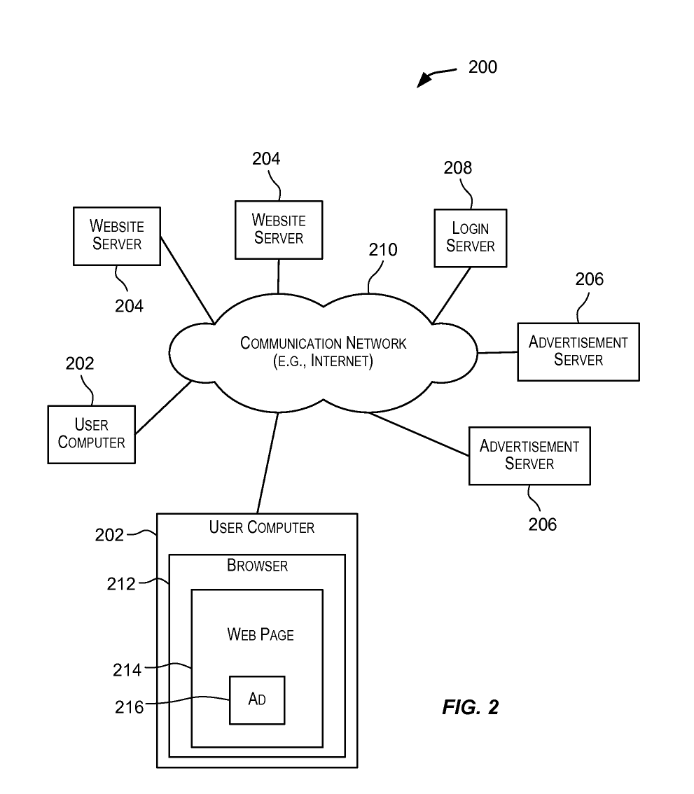

FIG. 2 is a simplified block diagram of a system 200 incorporating an embodiment of the present invention. The embodiment depicted in FIG. 2 is merely an example and is not intended to unduly limit the scope of embodiments of the present invention as recited in the claims. One of ordinary skill in the art would recognize many variations, alternatives, and modifications.

System 200 comprises several computer systems communicatively coupled to each other via communication network 210. In one embodiment, communication network 210 is the Internet. Communication network 210 may also be an Intranet, a local area network (LAN), a wide area network (WAN), an Ethernet network, or any communication network/infrastructure that enables communications between the various systems. A variety of communication protocols, including wired and wireless protocols, may be used for data communications over network 210 including but not limited to TCP/IP, SNA, IPX, AppleTalk, IEEE 802.XX (suite of protocols, the Bluetooth protocol, and/or other protocols or combination of protocols. The various systems depicted in FIG. 2 may be coupled to communication network 210 via links, which may include wired or wireless links.

The computer systems depicted in FIG. 2 include one or more user computers 202 that users may use to access content and resources provided by content provider systems connected to network 210. For example, a user may use a user computer 202 to access web pages stored by one or more website servers 204. A website server 204 may host one or more websites, each website comprising one or more web pages. A website hosted by a website server may be page-view based or a non page-view based website. The user may use an application program such as a browser 212 executing on user computer 202 to access the web pages. For example, a user may access a web page by providing a Uniform Resource Locator (URL) corresponding to a web page to browser 212 or by taking an action (e.g., clicking on a URL) that invokes a URL. A web page 214 (or in general, any document) corresponding to the URL is then loaded and displayed by the browser. Examples of browsers include different versions of Windows Internet Explorer, Mozilla Firefox, Apple Safari, Google Chrome, Opera, and others.

In addition to web pages, one or more advertisements 216 may also be loaded and output to the user along with the web page by the user computer. These advertisements may be provided by one or more advertisement servers 206. In one embodiment, advertisements may be displayed overlaid on the displayed web page.

Certain websites may require a user to login to the website (e.g., using a user ID and login password) before the user can access content provided by the website. For example, a website such as Facebook™ requires a user to login before the user can access web pages provided by the website. For a website that requires user login, a user typically has to first register and open an account with the website. Information provided by the user during the account opening or registration may be stored by the website. In FIG. 2, websites that require a login may be hosted by one or more servers 208 that a user can log into using the user's computer. For example, server 206 may host a social networking website such as Facebook™, an instant messaging server, and the like. A user may access and navigate web pages served by such a site after logging into the site. When logged in, server 208 typically maintains a session for the user and stores information related to the user's session on the website.

A website server may host both websites that require a login and those that do not. Accordingly, although login server 208 is shown separately from website serves 204 in FIG. 2, this is not intended to limit the scope of embodiments of the invention as recited in the claims. Further, a website server may host page-view based websites and/or non-page view based websites.

In one embodiment, special information is stored to enable an advertisement to be persisted across multiple pages served from a page-view based website. This special information is then used to determine whether an advertisement from a previously loaded web page is to be loaded and displayed, and accordingly persisted, for a newly loaded web page accessed by the user. In one embodiment, the same advertisement is loaded for the newly loaded web page without creating a new advertisement impression. The special information (referred to hereafter as “ad-persist information”) itself is also persisted across multiple page loads and enables an advertisement to be persisted across multiple web pages.

In one embodiment, the ad-persist information comprises two pieces of information: (1) advertisement data; and (2) expiration information. The advertisement data identifies the assets or a method for attaining the assets for rendering a specific advertisement. The specific advertisement may be an advertisement that was previously loaded and rendered on a web page previously accessed by the user. The advertisement data may include, for example, an Ad Identifier that is used to retrieve the assets needed to render the specific advertisement, information identifying locations of the actual assets for the specific advertisement such as the page to an image, a text caption, a URL, etc. In one embodiment, the assets are pieces or contents of the advertisement creative (images, sounds, videos, flash advertisements (SWF files), etc.) that an advertisement is comprised of. The advertising data may comprise all of the things that are used to display an advertisement, such as the ad creative (e.g., the stuff in the 900×400 and the leaderboard/media alert invitation state), the tracking pixels, click through URLs, other content, etc. In embodiment, the different pieces get created as DOM objects and added to the DOM (e.g., in the case of an iPhone app, the creative is in that native format).

The expiration information included in the ad-persist information is used to determine whether the specific advertisement corresponding to the advertisement data is to be persisted. In one embodiment, the expiration information identifies a condition under which to persist the specific advertisement corresponding to the advertisement data. The condition may be based upon different criteria.

In one embodiment, the expiration information may be based upon a time criterion. In such an embodiment, the expiration information comprises information that is used to determine whether an advertisement corresponding to the advertisement data is to be persisted. In one embodiment, the expiration information may indicate a time until which an advertisement corresponding to the advertisement data is to be persisted. If the newly loaded page is loaded prior to or within the specified time then the advertisement corresponding to the advertisement data is loaded and displayed using the advertisement data, else a request may be sent to an advertisement server for a new advertisement which is then loaded with the newly accessed page. In another embodiment, the expiration information may specify a time when the specific advertisement was last received from an advertisement server and loaded on a web page, and the system may be configured to load the same specific advertisement using the advertisement data for any web page accessed within a preconfigured time period from the time specified by the expiration information (e.g., 3 minutes from the time specified in the expiration information). The preconfigured time may be configurable.

As previously discussed, the condition specified in the expiration information, which determines whether the same specific advertisement is to be displayed, may be based upon different criteria. The criteria may include but is not restricted to the number of instant messages sent (or received or a combination thereof) by the user of the user computer, the number of user URL clicks, the number of interactions the user has had with previous web pages, whether or not the user has interacted with the specific advertisement on a previously loaded web page, the location in a workflow where the new web page is accessed (e.g., whether it is a login web page), other actions performed by the user, and the like, and combinations thereof.

In one embodiment, the ad-persist information described above may be stored on the user's computer, for example, in the form of a cookie. In alternative embodiments, the information may be stored on some other computer system depending upon the modes in which the user uses the user's computer to access or navigate web pages from page-view based websites. For example, in a first mode, the user may access multiple web pages served from a page-view based website using the user's computer without being logged into any server (no server session). In this mode (referred to as “non-login mode”), the ad-persist information may be stored on the user's computer and used to determine which advertisement to load and display when a web page is loaded and rendered for the user by the user computer. In a second mode, the user may navigate web pages while being logged into a web site server. In this second mode (referred to as “login mode”), the server into which the user has logged in (the logged-in server) may maintain a session for the user and store session information related to the user's online activities with the website. In this second mode, the ad-persist information may be tracked and stored by the server into which the user has logged in as part of the session information. The ad-persist information (or portions thereof) may also be stored collaboratively on the user system and the website server.

The two different modes are described below in further detail. It should however be apparent that embodiments of the present invention are not restricted to these two modes; embodiments of the present invention may also be applied to other modes.

### Non-Login Mode (First Mode)

In this mode, a user may use the user's computer to access web pages from page-view based websites (or non page-view based websites) without being logged into a server. The web pages may be accessed from a website but without logging into the website. In one embodiment, in this mode, the ad-persist information is persisted on the user's computer and used to determine whether an advertisement loaded and displayed with a previously loaded web page is to be loaded displayed (and thereby persisted) for a newly loaded web page.

There are different ways in which the ad-persist information may be persisted on the user's computer. In one embodiment, a cookie (e.g., an advertisement cookie) is used to persist the ad-persist information. In alternative embodiments, different types of client storage may be used including but not limited to browser cookies, flash cookies, browser local storage, and other types of client storage.

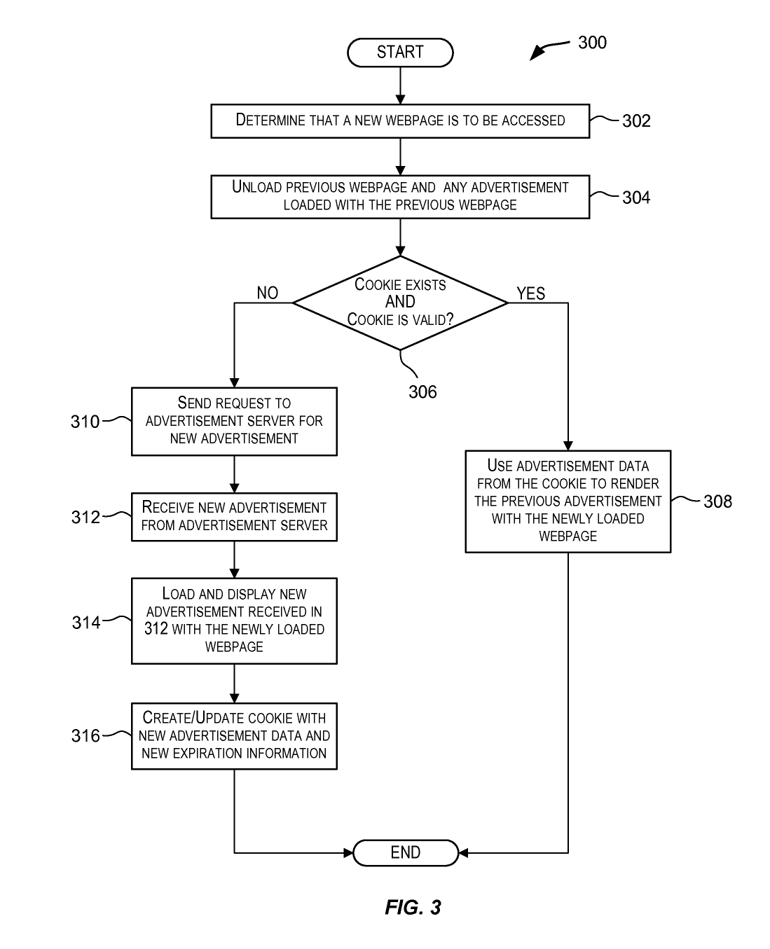

FIG. 3 depicts a simplified flowchart 300 depicting a method performed upon loading a new web page in the first (non-login) mode according to an embodiment of the present invention. In one embodiment, the processing depicted in FIG. 3 is performed by a user computer. The method depicted in FIG. 3 may be performed by software (e.g., code, program, instructions) executed by a processor in the user's computer, in hardware, or combinations thereof. The software may be stored on a computer-readable storage medium. The method depicted in FIG. 3 is not intended to limit the scope of the application as recited in the claims. It is assumed for FIG. 3 that the web pages are served from page-view based websites.

The embodiment depicted in FIG. 3 assumes that the ad-persist information is stored in the form of an advertisement cookie on the user's computer. The cookie comprises advertisement data related to a specific advertisement and expiration information. For purposes of this description, it is assumed that the expiration information specifies a time when the advertisement corresponding to the advertisement data was last received from an advertisement server and loaded on a web page.

As depicted in FIG. 3, processing may be initiated upon determining that a new web page is to be accessed (step 302). This may occur, for example, when the user selects a URL on a previously loaded web page or when the user provides a new URL to the browser. The previously loaded web page and any advertisement loaded with the previous web page are unloaded (step 304).

A check is them performed to see if the advertisement cookie stored on the user's computer both exists and is valid (step 306). Processing continues with step 308 if the cookie both exists and is valid, else processing continues with step 310.

A cookie storing ad-persist information may not exist if it has been deleted or not yet created. If the cookie does not exist, then it indicates that a new advertisement request is to be sent and processing continues with step 310.

If it is determined in 306 that the cookie exists, then the ad-persist information stored by the cookie is analyzed to determine if the cookie is still valid or has become invalid. In one embodiment, a cookie is considered to be invalid if the condition specified by the expiration information for persisting the advertisement corresponding to the advertisement data is no longer satisfied. For example, if the expiration information stored by the cookie indicates a time, the cookie is deemed to be invalid if, based upon the expiration information, it is determined that the time period for persisting the advertisement corresponding to the advertisement data has expired. In such a case the cookie is considered to have expired and invalid. An invalid cookie indicates that the advertisement corresponding to the advertisement data stored by the cookie is not to be persisted for the newly loaded web page. If the cookie has not expired and is valid, it indicates that the time for displaying the previously loaded advertisement has not expired and that the previously loaded advertisement is to be persisted for the newly loaded web page using the advertisement data.

There are different ways of determining whether the cookie has expired. For example, in one embodiment, the expiration information may identify a time when the advertisement corresponding to the advertisement data was last received from the advertisement server and loaded. The advertisement cookie may be considered to be invalid or expired if the time specified by the expiration information is more than “X” time units ago from the present time when the check in 306 is performed. The value of “X” may be user-configurable. In some embodiments, a default value of “X” may be set. The time units may be in seconds, minutes, etc. For example, if X is set to 3 minutes, then the advertisement cookie is considered invalid in 306 if the time specified by the expiration information, which denotes the time when the advertisement was last received and loaded from the advertisement server, is more the 3 minutes ago from the time of the check performed in 306. For example, if the expiration time indicates 11:06 pm and the check is performed at 11:15 pm, then the cookie is deemed to be invalid. However, if the expiration time indicates 11:14 pm and the check is performed at 11:15 pm, then the cookie deemed to be valid.

In another embodiment, the expiration information may itself indicate a time until which the cookie is to be deemed valid. For example, if an advertisement was loaded at 1:00 pm and the advertisement is to be persisted for 5 minutes, the expiration time may be set to 1:05 pm. If the check in 306 is performed on or before 1:05 pm then the cookie is deemed valid, else it is deemed to be invalid (i.e., the time period for persisting the advertisement has expired).

If it is determined in 306 that the advertisement cookie both exists and is valid, this indicates that the advertisement corresponding to the advertisement data stored by the cookie (i.e., the previously loaded advertisement) is to be reloaded for the new web page using data from the advertisement data stored by the cookie and without making any new advertisement impression. Accordingly, the advertisement data from the advertisement cookie is used to render the previously loaded advertisement (i.e., the advertisement corresponding to the advertisement data) along with the newly loaded web page (step 308). In this case, there is no advertisement request sent to an advertisement server. Consequently, rendering of the advertisement for the new web page does not create a new advertisement impression for the advertisement.

If it is determined in 306 that the advertisement cookie does not exist, is invalid, or both, it indicates that a new advertisement is to be displayed. Accordingly, a request is sent to an advertisement server for a new advertisement (step 310). This results in a new advertisement impression. A new advertisement is then received from the advertisement server in response to the request sent in 308 (step 312). The new advertisement is then loaded along with the newly loaded web page and displayed (step 314).

If an advertisement cookie does not already exist, an advertisement cookie is created and updated based upon the loaded advertisement. If the advertisement cookie already exists, then the information stored by the cookie is updated for the newly loaded advertisement. As part of the update, the advertisement data stored by the cookie may be updated corresponding to the new advertisement received in 312. In one embodiment, the advertisement data is updated to store information that can be subsequently used to re-render the advertisement without making a new advertisement impression. The expiration information is updated to specify a time associated with the new advertisement. For example, in one embodiment, the expiration information is set to reflect the time when the new advertisement was received from the advertisement server and loaded.

In the manner described above, the advertisement data and expiration information stored by the user computer is used to determine which advertisement is to be displayed when a new page from a page-view based site is loaded by the user computer. The expiration information indicates whether the previously loaded advertisement is to be redisplayed and persisted or whether a new advertisement is to be sought and displayed.

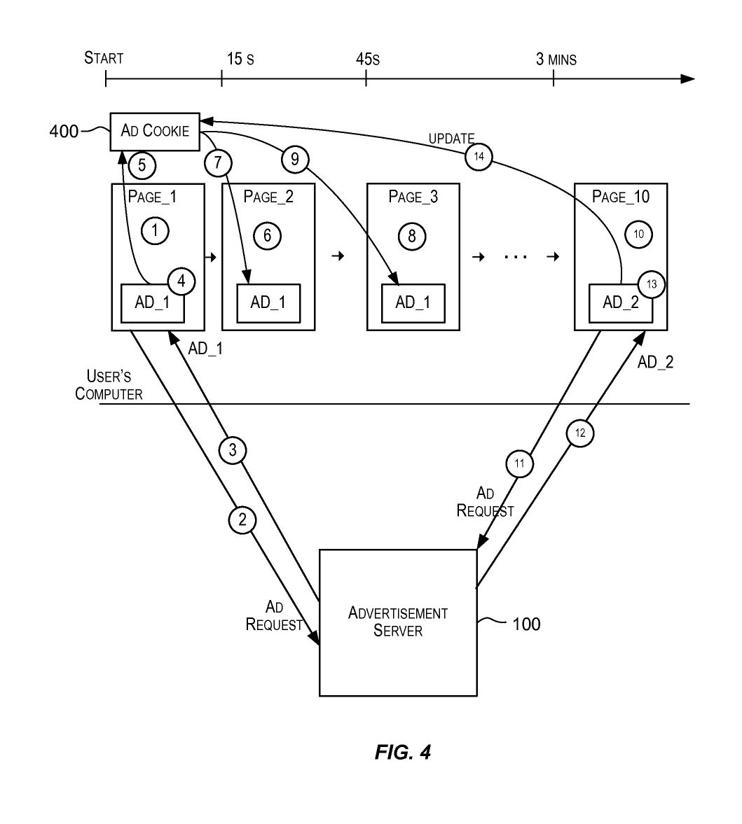

FIG. 4 depicts processing performed by a user computer and an advertisement server for persisting an advertisement across multiple web pages accessed by a user in non-login mode according to an embodiment of the present invention. It is assumed that the web pages accessed in FIG. 4 are served from one or more page-view based websites.

As depicted in FIG. 4, the user navigates through ten web pages (PAGE_1 through PAGE_10) in a little over three minutes. At the start the user accesses a web page PAGE_1 (step (1)). Web page PAGE_1 may be served from a page-view based website and loaded in a browser executing on the user's computer. It is assumed that no advertisement cookie exists at this time. As a result, a request is sent to advertisement server 100 for a new advertisement to be loaded and displayed with PAGE_1 (step (2)). An advertisement AD_1 is served by advertisement server 100 in response to the request (step (3)). Advertisement AD_1 is then loaded and displayed by the user computer along with PAGE_1 (step (4)). An advertisement cookie 400 is then created and updated with new advertisement data corresponding to AD_1 and expiration information (step (5)). The expiration information may, for example, specify the time when AD_1 was received by the user computer from the advertisement server and loaded/displayed on PAGE_1. For purposes of this example, it is further assumed that the advertisement cookie is considered to be invalid if the time specified by the expiration information is more than 3 minutes ago from when the validity check is performed.

Within 15 seconds of accessing PAGE_1, the user accesses another web page PAGE_2 (step (6)). Since the advertisement cookie 400 both exists and is valid (since the time when the check is performed is within 3 minutes of the time specified by the expiration information in the advertisement cookie), the same advertisement (AD_1) is loaded and rendered using the advertisement data from advertisement cookie 400 on PAGE_2 (step (7)). There is no advertisement request sent to advertisement server 100 and as a result no new advertisement impression generated. In this manner, the same AD_1 that was rendered on PAGE_1 is now rendered on PAGE_2 and thus persisted across multiple web pages.

At 45 seconds, the user accesses a new web page PAGE_3 (step (8)). Since the advertisement cookie 400 both exists and is valid (i.e., the time is still within 3 minutes of the time specified by the expiration information in the advertisement cookie), the same advertisement (AD_1) is again rendered using the advertisement data from advertisement cookie 400 (step (9)). There is no advertisement request sent to advertisement server 100 and as a result no new advertisement impression generated. In this manner, the same AD_1 that was rendered on PAGE_1 and PAGE_2 is now rendered on PAGE_3 using the advertisement data from the advertisement cookie 400. In this manner, advertisement cookie 400 is used to render the same advertisement (AD_1) across multiple web pages while the advertisement cookie both exists and is valid. During this time there is no need to send an advertisement request to advertisement server 100 thereby preventing any new advertisement impressions.

Just after the 3 minute mark, the user accesses the tenth web page PAGE_10 (step (10)). At this time it is determined that advertisement cookie 400 is invalid since it is more than 3 minutes since the time specified in the expiration information of the advertisement cookie. Accordingly, a request for a new advertisement is sent to advertisement server 100 (step (11)) and a new advertisement AD_2 received in response from advertisement server 100 (step (12)). The new advertisement AD_2 is then loaded and displayed by the user computer with the newly loaded web page PAGE_10 (step (13)). Advertisement cookie 400 is updated with information corresponding to the new advertisement AD_2 (step (14)). The advertisement data of the cookie is updated corresponding to AD_2 and the expiration information is set to specify a time when AD_2 was received from advertisement server 100 and loaded with PAGE_10.

In the manner shown above, the ad-persist information stored on the user's computer in the form of an advertisement cookie is used to persist an advertisement across multiple web pages accessed by the user using the user's computer.

### Login Mode (Second Mode)

In this mode, a user accesses web pages while logged into a server. For example, a user may log into a social networking site server or an instant messaging server using the user's computer and then navigate through web pages while logged in. The logged-in server may maintain a session for the user and store session information for the user. In this mode, the ad-persist information that is used to determine whether a previously loaded advertisement is to be persisted may be stored on the user's computer (e.g., using an advertisement cookie), or on the server, or on both the user's system and the server.

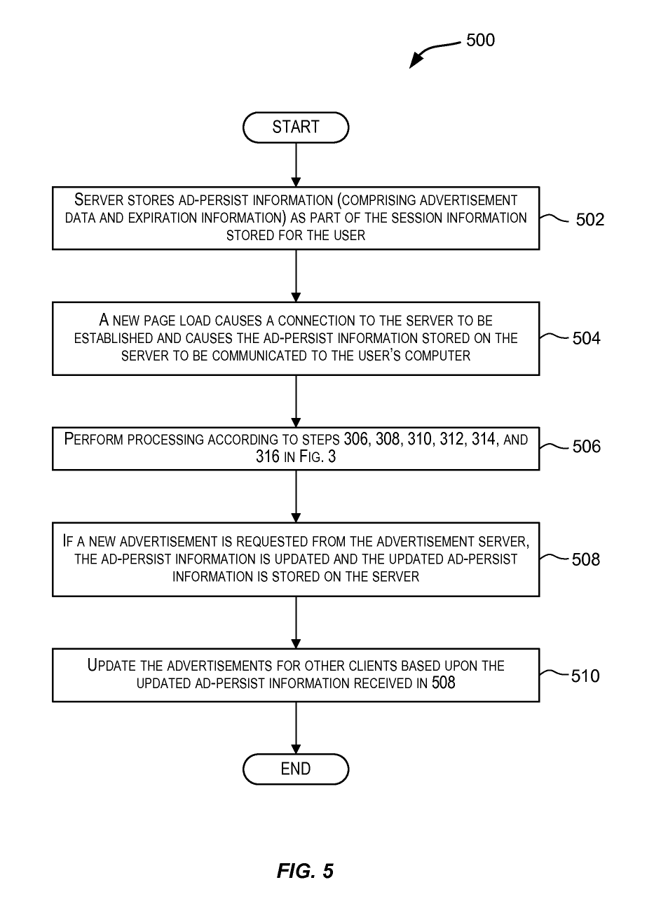

FIG. 5 depicts a simplified flowchart 500 depicting a method performed for loading a new web page in login mode according to an embodiment of the present invention. The method depicted in FIG. 5 may be performed by software (e.g., code, program, instructions) executed by a processor, in hardware, or combinations thereof. The software may be stored on a computer-readable storage medium. The method depicted in FIG. 5 is not intended to limit the scope of the application as recited in the claims. It is assumed for FIG. 5 that the web pages are served from page-view based websites.

The method depicted in FIG. 5 assumes that the user accesses a new web page while being logged into a server. The server may maintain session information for the user and store the ad-persist information (or portions thereof), comprising advertisement data and expiration information, as part of the session information (step 502). The session information may also comprise other information related to the user's session.

A new web page load causes a connection to be established from the user's computer to the server and further causes the ad-persist information, if any, stored by the server to be communicated to the user's computer (step 504). In one embodiment, the new web page being loaded may comprise code that causes a connection to the server to be established, establishes a session, and causes the ad-persist information stored by the server to be communicated to the user's computer. Once the ad-persist information is received by the user's computer, processing may proceed as per steps 306, 308, 310, 312, 314, and 316 depicted in FIG. 3 using the ad-persist information received from the server (step 506). As part of 506, a determination is made if the ad-persist information exists and is invalid and appropriate actions are taken accordingly as depicted in FIG. 3 and described above.

If the processing in 506 causes a new advertisement to be requested from an advertisement server, then the ad-persist information is updated to reflect that and the updated ad-persist information is then communicated back to the server to be stored as part of the session information stored by the server (step 508). In one embodiment, as part of 508, the ad-persist information is updated on the user's system and then communicated from the user's computer to the server and stored by the server. In this manner, the ad-persist information stored on the server is kept in synchrony with any updates made on the user's computer. In one embodiment, the user's computer may issue a command to the server to store the updated advertisement cookie information.

In one embodiment, there may be multiple clients displaying advertisements based upon the ad-persist information. These clients may correspond to different programs/applications, different processes/threads within the same program/application, and the like. Clients may be on the same machine or different machines. For example, a browser may have multiples tabs, with each tab being considered as a client. Different tabs may display web pages and advertisements rendered by the tabs may be based upon the ad-persist information. In one embodiment, the clients that are affected by the ad-persist information may be clients that are connected to the same session. In an environment with multiple clients being affected by the ad-persist information, the updated ad-persist information may then be used to update the advertisements displayed for one or more other clients (step 508).

For example, a user on the user's computer may have two separate web pages opened in two separate tabs of a browser (or even two web pages opened in two different instances of a browser). These represent two separate clients and may be part of the same session maintained by the server. In such a scenario, when the ad-persist information is updated due to a new advertisement displayed on the first web page (first client), the updated ad-persist information may then be used to update the advertisement displayed on the second web page (second client). In this manner, the updated ad-persist information stored by the server may be used to persist or update the advertisements rendered on separate web pages in separate clients. The clients may be on the same user system or even on different user systems.

In the embodiment depicted in FIG. 5 and described above, processing to determine whether the ad-persist information exists and is valid is performed on the user's computer. In alternative embodiments, the processing may be performed by the server storing the session information (or some other server). In such an embodiment, there is no need to communicate the ad-persist information to the user's computer. Processing performed by the server then causes either a new advertisement request to be sent or a previously loaded advertisement to be persisted across web pages loaded from a page-view based website.

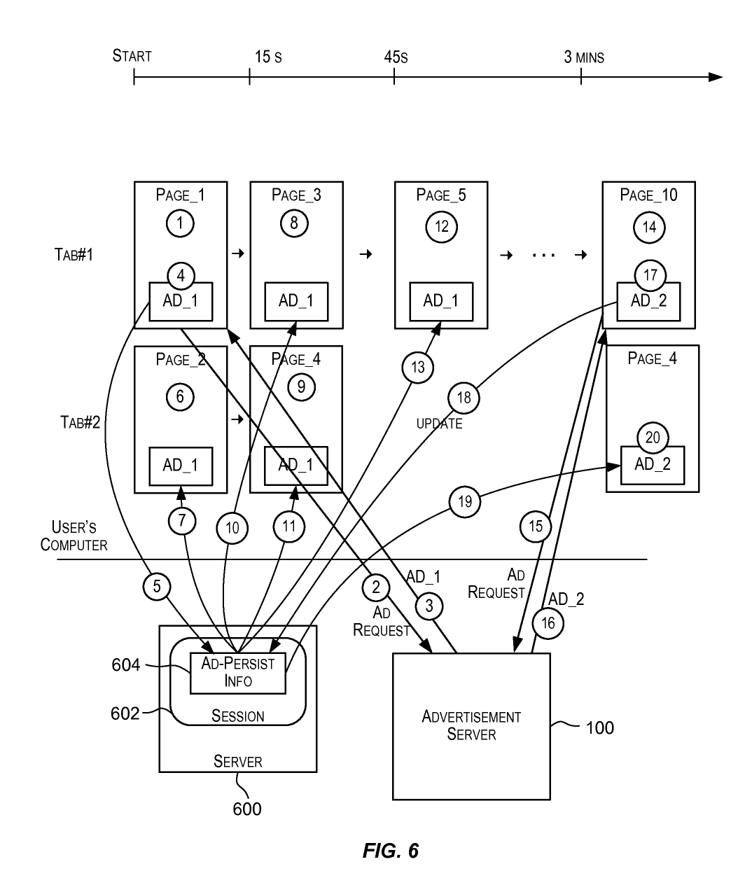

FIG. 6 depicts processing performed by a user computer, an advertisement server, and a login server for persisting an advertisement across multiple web pages, possibly across multiple clients, in login mode according to an embodiment of the present invention. As depicted in FIG. 6, the user navigates through ten web pages (PAGE_1 through PAGE_10) in a little over three minutes. It is assumed that the user accesses web pages while logged into (or signed into) server 600. Server 600 may, for example, be a website server. The user may access web pages using separate clients (e.g., two separate tabs of a browser) with both clients connected to the same session maintained by server 600. Server 600 stores session information 602 for the user session. It is assumed that the web pages accessed in FIG. 6 are served from one or more page-view based websites.

As depicted in FIG. 6, the user starts out by accessing web page PAGE_1 on the user's computer (step (1)). PAGE_1 may be loaded and displayed in a first tab (Tab#1) of a browser executing on the user's computer. It is assumed that no ad-persist information is stored by server 600 at this point in time. As a result of PAGE_1 being accessed, a request is sent to advertisement server 100 for an advertisement to be loaded and displayed with PAGE_1 (step (2)). An advertisement AD_1 is then served to the user's computer by advertisement server 100 in response to the request (step (3)). The advertisement AD_1 may then be loaded and displayed along with PAGE_1 by the user's computer (step (4)).

Ad-persist information 604 is then created and stored on server 600 as part of session information 602 (step (5)). As part of step (5), ad-persist information may be created on the user's computer and communicated to server 600. The ad-persist information comprises advertisement data corresponding to AD_1 and expiration information. The expiration information may specify the time when AD_1 was received from advertisement server 100 and loaded with PAGE_1. For purposes of this description, the system may be configured such that the ad-persist information is considered to be invalid if the time specified by the expiration information is more than 3 minutes ago from when the validity check is performed. In an alternative embodiment, the expiration information may identify the time until which the ad-persist information is to be considered valid (e.g., the time when AD_1 was loaded plus three minutes).

The user may then access web page PAGE_2 on a second tab (Tab#2) of the browser on the user's computer (step (6)). Tab#2 represents a second client. It is determined that ad-persist information 604 stored by server 600 both exists and is valid (i.e., the time is still within 3 minutes of the time specified by the expiration information in the ad-persist information). In one embodiment, accessing web page PAGE_2 causes the ad-persist information 604 stored by server 600 to be communicated to the user's computer and the check is then performed on the user computer. In an alternative embodiment, the check may be performed by server 600. Based upon the stored ad-persist information 604, the same advertisement (AD_1) is loaded and rendered on PAGE_2 using the advertisement data portion of the ad-persist information (step (7)). The advertisement data from ad-persist information 604 may be used to determine and render AD_1. It is to be noted here that AD_1 is loaded and rendered for PAGE_2 without any advertisement request being sent to advertisement server 100 without generating a new advertisement impression. In this manner, the same AD_1 that was rendered for PAGE_1 is now rendered for PAGE_2 using ad-persist information 604 stored by server 600.

At 45 seconds, the user navigates from PAGE_1 to PAGE_3 in Tab#1 (step (8)) and from PAGE_2 to PAGE_4 in Tab#2 (step (9)). It is determined in response to both the web page loads that ad-persist information 604 stored by server 600 both exists and is valid (i.e., the time is still within 3 minutes of the time specified by the expiration information in the ad-persist information). Accordingly, the same advertisement (AD_1) is rendered using the advertisement data from the stored ad-persist information 604 for both web pages PAGE_3 (step (10)) and PAGE_4 (step (11)). There are no advertisement requests sent to advertisement server 100 for loading AD_1 on web pages PAGE_3 and PAGE_4 and as a result no new advertisement impressions are generated.

The user then navigates from PAGE_3 to PAGE_5 at the 45 second mark in Tab#1 (step (12)). It is determined that ad-persist information 604 stored by server 600 both exists and is valid (i.e., the time is still within 3 minutes of the time specified by the expiration information in the advertisement cookie). Accordingly, the same advertisement (AD_1) is rendered for PAGE_5 using the advertisement data from ad-persist information 604 (step (13)). There is no advertisement request sent to advertisement server 100 and as a result no new advertisement impression is generated.

The user continues to navigate different web pages from PAGE_5 in Tab#1 and just after the 3 minute mark navigates to PAGE_10 (at this time PAGE_4 is still loaded in the other tab) (step (14)). At this time it is determined that ad-persist information 604 stored by server 600 is invalid since it is now more than 3 minutes past the time specified in the expiration information of the ad-persist information. Accordingly, a request for a new advertisement is sent to advertisement server 100 (step (15)) and a new advertisement AD_2 received in response (step (16)). This causes a new advertisement impression. The new advertisement AD_2 received in response to the advertisement request is then loaded and displayed with the newly loaded web page PAGE_10 (step (17)). Ad-persist information 604 stored by server 600 is then updated to reflect the new advertisement (step (18)). The advertisement data of the ad-persist information is updated for AD_2 and the expiration information is updated to reflect the time when AD_2 was received from advertisement server 100 and loaded by the user's computer. In one embodiment, the ad-persist information is updated on the user's system and then communicated to server 600 for storage.

Based upon the updated ad-persist information maintained by server 600, a notification is sent from server 600 to the second client (TAB#2 displaying PAGE_4) to update the advertisement displayed by the client (step (19)). This causes the advertisement displayed on PAGE_4 to be updated to display new advertisement AD_2 instead of AD_1 (step (20)). In one embodiment this may be done in response to trigger such as a user click action. Since AD_2 on PAGE_4 is rendered using the stored ad-persist information, no new advertisement impression is generated. Accordingly, in the processing depicted in FIG. 6, there are only two advertisement requests sent to advertisement server 100 (steps (2) and (15)) even though more than two web page loads have occurred.

In one embodiment, for purposes of efficiency, the ad-persist information may be cached on the user's computer in addition to the information being stored in server 600. For example, the ad-persist information may be cached in the form of a cookie on the user's computer. Caching the information on the user's computer reduces the data communications between server 600 and the user's system and in turn may reduce the processing time. However, there is no requirement to cache the ad-persist information on the user's computer in login mode.

In the manner described above, an advertisement may be persisted across multiple web pages in login mode without creating new advertisement impressions. Further, the session information stored by a server may be used to display advertisements across multiple web pages across multiple clients and domains.

As described above, an advertisement may be persisted across multiple web pages in either a non-login or login mode. In one embodiment, an advertisement may also be persisted across web pages when a user switches between the two modes. Accordingly, an advertisement may be persisted across web pages accessed in different modes. For example, when a user switches from a non-login mode to a login mode, the advertisement cookie stored on the user's computer may be communicated to the server and the ad-persist information represented by the cookie may be stored by the server as part of the session information for the user. The ad-persist information may then be used to persist web pages across multiple web pages across one or more clients, as described above for the login mode embodiment. When a user switches from a login mode to a non-login mode, the ad-persist information stored by the server may be communicated to the user's system and stored on the user's system. For example, the ad-persist information may be stored on the user's computer in the form of an advertisement cookie. The advertisement cookie on the user's system may then be used to persist an advertisement across multiple web pages, as described above for the non-login mode embodiment.

Further, in one embodiment, even if a user is logged in, processing according to the non login mode may be performed using ad-persist information stored on the user's computer to persist advertisement across multiple web pages without making advertisement calls to the advertisement server. Further, processing according to the login mode and non-login mode may even be performed in parallel for a user.

In one embodiment, the ad-persist information may be used to determine a position where an advertisement is to be displayed. For example, in addition to advertisement data and expiration information, the ad-persist information may also comprise location information identifying a position where an advertisement was displayed on or relative to a previously loaded web page. Using this position information, when the same advertisement is being persisted on a newly loaded web page, the location information in the ad-persist information may be used to determine the location for rendering the advertisement. In this manner, the advertisement may be rendered in the same position on/relative to a newly loaded web page, in effect persisting the location where the advertisement is rendered. Rendering the same advertisement in the same location across multiple web pages increases the likelihood that the user will notice the advertisement and interact with the advertisement.

Showing the same advertisement across multiple pages using the advertisement data stored as part of the ad-persist information reduces the number of advertisement impressions. Since the time length for which an advertisement is persisted is user-configurable, an appropriate time length may be set that increases the amount of time that a user can see or is exposed to the advertisement. This increases the probability that the user will click on or interact with the advertisement. This in turn may help increase the click rate for the advertisement which will make the advertisement perform better for the advertiser. This also offers a better user experience for several reasons such as (1) the bombardment of multiple advertisements for every new web page load is avoided (resulting in reduced impressions), (2) the page navigation experience for the user is enhanced (faster page loads) since the time spent in requesting a new advertisement from the advertisement server for every web page is avoided, and (3) the user has more time to notice the advertisement and an opportunity to engage the advertisement.

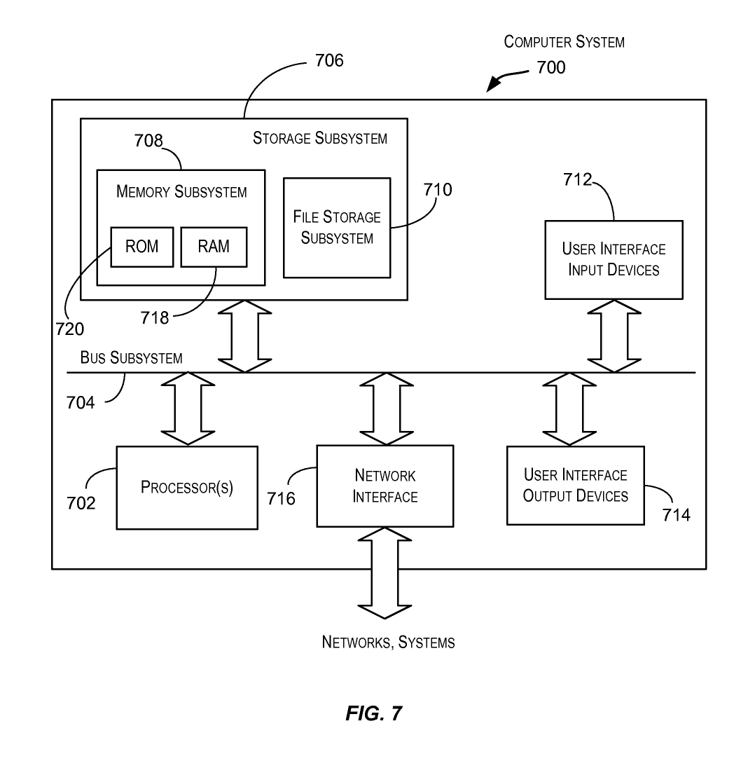

FIG. 7 is a simplified block diagram of a computer system 700 that may be used to practice an embodiment of the present invention. In various embodiments, computer system 700 may be used to implement any of the computers illustrated in FIG. 2 described above. For example, one or more computer systems 700 may be used to implement user computers 202, advertisement servers 206, website servers 204, and servers 208 depicted in FIG. 2. As shown in FIG. 7, computer system 700 includes a processor 702 that communicates with a number of peripheral subsystems via a bus subsystem 704. These peripheral subsystems may include a storage subsystem 706, comprising a memory subsystem 708 and a file storage subsystem 710, user interface input devices 712, user interface output devices 714, and a network interface subsystem 716.

Bus subsystem 704 provides a mechanism for letting the various components and subsystems of computer system 700 communicate with each other as intended. Although bus subsystem 704 is shown schematically as a single bus, alternative embodiments of the bus subsystem may utilize multiple busses.

Network interface subsystem 716 provides an interface to other computer systems and networks. Network interface subsystem 716 serves as an interface for receiving data from and transmitting data to other systems from computer system 700. For example, network interface subsystem 716 may enable a user computer to connect to the Internet and facilitate communications using the Internet.

User interface input devices 712 may include a keyboard, pointing devices such as a mouse, trackball, touchpad, or graphics tablet, a scanner, a barcode scanner, a touch screen incorporated into the display, audio input devices such as voice recognition systems, microphones, and other types of input devices. In general, use of the term “input device” is intended to include all possible types of devices and mechanisms for inputting information to computer system 700.

User interface output devices 714 may include a display subsystem, a printer, a fax machine, or non-visual displays such as audio output devices, etc. The display subsystem may be a cathode ray tube (CRT), a flat-panel device such as a liquid crystal display (LCD), or a projection device. In general, use of the term “output device” is intended to include all possible types of devices and mechanisms for outputting information from computer system 700.

Storage subsystem 706 provides a computer-readable storage medium for storing the basic programming and data constructs that provide the functionality of the present invention. Software (programs, code modules, instructions) that when executed by a processor provide the functionality of the present invention may be stored in storage subsystem 706. These software modules or instructions may be executed by processor(s) 702. Storage subsystem 706 may also provide a repository for storing data used in accordance with the present invention. For example, an advertisement cookie may be stored in storage subsystem 706. Storage subsystem 706 may comprise memory subsystem 708 and file/disk storage subsystem 710.

Memory subsystem 708 may include a number of memories including a main random access memory (RAM) 718 for storage of instructions and data during program execution and a read only memory (ROM) 720 in which fixed instructions are stored. File storage subsystem 710 provides persistent (non-volatile) storage for program and data files, and may include a hard disk drive, a floppy disk drive along with associated removable media, a Compact Disk Read Only Memory (CD-ROM) drive, an optical drive, removable media cartridges, and other storage media.

Computer system 700 can be of various types including a personal computer, a portable computer, a workstation, a network computer, a mainframe, a kiosk, a server or any other data processing system. Due to the ever-changing nature of computers and networks, the description of computer system 700 depicted in FIG. 7 is intended only as a specific example for purposes of illustrating the preferred embodiment of the computer system. Many other configurations having more or fewer components than the system depicted in FIG. 7 are possible.

Although specific embodiments of the invention have been described, various modifications, alterations, alternative constructions, and equivalents are also encompassed within the scope of the invention. Embodiments of the present invention are not restricted to operation within certain specific data processing environments, but are free to operate within a plurality of data processing environments. Additionally, although embodiments of the present invention have been described using a particular series of transactions and steps, it should be apparent to those skilled in the art that the scope of the present invention is not limited to the described series of transactions and steps.

Further, while embodiments of the present invention have been described using a particular combination of hardware and software, it should be recognized that other combinations of hardware and software are also within the scope of the present invention. Embodiments of the present invention may be implemented only in hardware, or only in software, or using combinations thereof.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims.

What is claimed is:

1. A computer-implemented method for displaying an advertisement, the method comprising:
loading, by a processing system, a first web page;
loading, by the processing system, a first advertisement in response to loading the first web page, the first advertisement received from an advertisement server;
storing first information comprising information related to the first advertisement;
unloading, by the processing system, the first web page and the first advertisement;
loading, by the processing system, a second web page; and
determining, based upon the first information, whether the first advertisement is to be displayed again in response to loading the second web page.

2. The method of claim 1 further comprising:
upon determining that the first advertisement is to be displayed for the second web page, causing the first advertisement to be loaded using the first information without sending a request for the first advertisement to the advertisement server.

3. The method of claim 1 further comprising:
upon determining that the first advertisement is not to be displayed for the second web page:
communicating a request for another advertisement;
receiving the another advertisement;
causing the another advertisement to be loaded; and
updating the first information to store information related to the another advertisement.

4. The method of claim 3:
wherein the second web page and the another advertisement are displayed in a first client;
the method further comprising causing the another advertisement to be displayed for a third web page displayed by a second client different from the first client using the updated first information.

5. The method of claim 1 wherein:
the first information comprises time information related to the first advertisement;
the determining comprises determining based upon the time information whether the first advertisement is to be displayed for the second web page.

6. The method of claim 5 wherein:
the time information indicates a time when the first advertisement was loaded in response to loading the first web page; and
determining based upon the time information whether the first advertisement is to be displayed comprises:
determining, based upon the time indicated by the time information, whether a time period for displaying the first advertisement has expired;
determining that the first advertisement is to be displayed for the second web page if it is determined that the time period for displaying the first advertisement has not expired; and
determining that the first advertisement is not to be displayed for the second web page if it is determined that the time period for displaying the first advertisement has expired.

7. The method of claim 1 wherein storing the first information comprises storing the first information on the processing system.

8. The method of claim 1 wherein storing the first information comprises storing the first information on a server system separate from the processing system.

9. A computer-readable storage medium storing a plurality of instructions for controlling a processor, the plurality of instructions comprising:
instructions that cause the processor to load a first web page;
instructions that cause the processor to load a first advertisement in response to loading the first web page, the first advertisement received from an advertisement server;
instructions that cause the processor to store first information comprising information related to the first advertisement;
instructions that cause the processor to unload the first web page and the first advertisement;
instructions that cause the processor to load a second web page; and
instructions that cause the processor to determine, based upon the first information, whether the first advertisement is to be displayed again in response to loading the second web page.

10. The computer-readable storage medium of claim 9 wherein the plurality of instructions further comprises:
instructions that cause the processor to, upon determining that the first advertisement is to be displayed for the second web page, cause the first advertisement to be loaded using the first information without sending a request for the first advertisement to the advertisement server.

11. The computer-readable storage medium of claim 9 wherein the plurality of instructions further comprises, upon determining that the first advertisement is not to be displayed for the second web page:
instructions that cause the processor to communicate a request for another advertisement;
instructions that cause the processor to receive the another advertisement;
instructions that cause the processor to cause the another advertisement to be loaded; and
instructions that cause the processor to update the first information to store information related to the another advertisement.

12. The computer-readable storage medium of claim 11:
wherein the second web page and the another advertisement are displayed in a first client;
the plurality of instructions further comprise instructions that cause the processor to cause the another advertisement to be displayed for a third web page displayed by a second client different from the first client using the updated first information.

13. The computer-readable storage medium of claim 9 wherein:
the first information comprises time information related to the first advertisement;
the instructions that cause the processor to determine comprise instructions that cause the processor to determine, based upon the time information, whether the first advertisement is to be displayed for the second web page.

14. The computer-readable storage medium of claim 13 wherein:
the time information indicates a time when the first advertisement was loaded in response to loading the first web page; and
the instructions that cause the processor to determine, based upon the time information, whether the first advertisement is to be displayed comprise:
instructions that cause the processor to determine, based upon the time indicated by the time information, whether a time period for displaying the first advertisement has expired;
instructions that cause the processor to determine that the first advertisement is to be displayed for the second web page if it is determined that the time period for displaying the first advertisement has not expired; and
instructions that cause the processor to determine that the first advertisement is not to be displayed for the second web page if it is determined that the time period for displaying the first advertisement has expired.

15. The computer-readable storage medium of claim 9 wherein the instructions that cause the processor to store the first information comprise instructions that cause the processor to store the first information on a processing system displaying the first advertisement.

16. The computer-readable storage medium of claim 9 wherein the instructions that cause the processor to store the first information comprise instructions that cause the processor to store the first information on a server system separate from a system displaying the first advertisement.

17. A system comprising:
a memory; and
a processor coupled to the memory, the processor configured to:
cause a first web page to be displayed;
cause a first advertisement to be loaded in response to loading the first web page, the first advertisement received from an advertisement server;
cause first information to be stored in the memory, the first information comprising information related to the first advertisement;
cause the first web page and the first advertisement to be unloaded;
cause a second web page to be loaded; and
determine, based upon the first information, whether the first advertisement is to be displayed again in response to loading the second web page.

18. The system of claim 17 wherein the processor is configured to:
upon determining that the first advertisement is to be displayed for the second web page, cause the first advertisement to be loaded using the first information without sending a request for the first advertisement to the advertisement server.

19. The system of claim 17 wherein the processor is configured to, upon determining that the first advertisement is not to be displayed for the second web page:
cause a request for another advertisement to be communicated;
receive the another advertisement;
cause the another advertisement to be loaded; and
update the first information to store information related to the another advertisement.

20. The system of claim 19:
wherein the second web page and the another advertisement are displayed in a first client;
the processor is configured to cause the another advertisement to be displayed for a third web page displayed by a second client different from the first client using the updated first information.

21. The system of claim 17 wherein:
the first information comprises time information related to the first advertisement;
the processor is configured to determine, based upon the time information, whether the first advertisement is to be displayed for the second web page.

22. The system of claim 21 wherein:
the time information indicates a time when the first advertisement was loaded in response to loading the first web page; and
the processor is configured to:
determine, based upon the time indicated by the time information, whether a time period for displaying the first advertisement has expired;
determine that the first advertisement is to be displayed for the second web page if it is determined that the time period for displaying the first advertisement has not expired; and
determine that the first advertisement is not to be displayed for the second web page if it is determined that the time period for displaying the first advertisement has expired.

23. The system of claim 17 wherein the processor is configured to cause the first information to be stored on a server system.
